(19) United States
(12) Patent Application Publication
(10) Pub. No.: US 2016/0349204 A1
(43) Pub. Date: Dec. 1, 2016

(54) DEVICE AND METHOD FOR DETERMINING AN OZONE CONCENTRATION

(71) Applicant: Innovatec Geratetechnik GmbH, D-53359 Rheinbach (DE)

(72) Inventor: Samuel Stucki, Nussbaumen (CH)

(21) Appl. No.: 15/165,129

(22) Filed: May 26, 2016

(30) Foreign Application Priority Data
May 29, 2015 (DE) 10 2015108 496.1

(51) Int. Cl. G01N 27/406

(52) U.S. Cl. CPC G01N 27/406

(57) ABSTRACT

A device for determining an ozone concentration in an aqueous solution, and the device has at least one measuring electrode that can be immersed in the aqueous solution, at least one cationic exchange material as a solid electrolyte that can be immersed with a first end in the aqueous solution and with a second end that protrudes out from the aqueous solution, its second end being in contact with a reference electrode. In order to determine the ozone concentration, the first end of the cationic exchange material in the aqueous solution can be contacted by the measuring electrode.

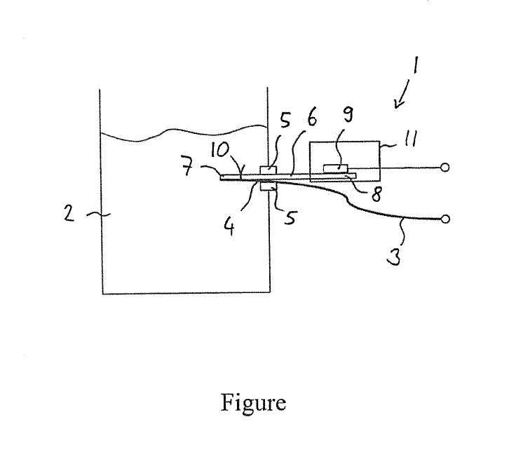

### BACKGROUND OF THE INVENTION

Field of the Invention

This invention relates to a device for determining an ozone concentration and the use thereof and also to a method for determining an ozone concentration.

Discussion of Related Art

To measure oxidizing agents such as ozone that are dissolved in water, potentiometry is a measurement technique that is easy to implement. If other potential-determining species aside from ozone (oxidizing agents or reducing agents) can be ruled out, the concentration of ozone can be determined with a very rapid response time using the Nernst equation with a simple potential measurement:

E=E₀+RT/zF·Inc,

where E is the potential measured against a suitable reference, E₀ is the potential under normal conditions (c=1) R is the gas constant, T is the temperature, z is the number of electrons that are transferred in the potential-determining reaction by formula conversion, F is the Faraday constant, and c is the concentration of the potential-determining species.

In some applications, however, problems arise with the use of classical potentiometry. For example, in ultrapure water, the setting of a definite electrode potential is dependent on extremely low percentages of impurities that cannot be controlled and thus is hardly informative. In this case, potentiometry does not provide sufficiently precise results. In addition, because of the low ion concentration in ultrapure water, there is a high electrical resistance in the measurement chain, which can cause problems from a measurement standpoint.

Problems also occur if the ozone concentration is measured in the presence of dissolved reducing agents, such as hydrogen. In this case, the dissolved reducing agents distort the measurement and in most cases, make it impossible to establish a correlation between the electrode potential and ozone concentration. In uses such as water treatment, when ozone is produced electrolytically, if there is insufficient separation of the hydrogen, then it is present in addition to the ozone dissolved in the water. It is then frequently not possible to determine the ozone concentration using potentiometry.

### SUMMARY OF THE INVENTION

The above object and others of this invention are accomplished with a device for determining an ozone concentration in an aqueous solution, which permits a sufficiently precise determination of the ozone concentration even in ultrapure water and in the presence of dissolved hydrogen. This invention also discloses a method for determining an ozone concentration in ultrapure water and/or in the presence of dissolved hydrogen.

These objects and others are attained by the subject of embodiments of this invention as described in this specification and in the claims.

According to one embodiment of this invention, a device for determining an ozone concentration in an aqueous solution is disclosed. The device has at least one measuring electrode, which can be immersed in the aqueous solution. The device also has at least one cationic exchange material as a solid electrolyte, which can be immersed with a first end in the aqueous solution and with a second end and which protrudes out from the aqueous solution and with its second end, it contacts a reference electrode. In order to determine the ozone concentration in this case, the first end of the cationic exchange material in the aqueous solution can be contacted by the measuring electrode.

The use of the solid electrolyte, which is present in protonated form in the solution, solves the problem of the low conductivity of ultrapure water. At the interface between the solid electrolyte and the measuring electrode, a potential is established, which is dependent on the concentration of the ozone dissolved in the water.

The device has one advantage that it makes it possible to reliably determine the ozone concentration even in ultrapure water and in in aqueous solutions with low ion concentrations.

In one embodiment, the cationic exchange material is a PFSA material. The abbreviation PFSA stands for perfluorinated sulfonic acid. Such materials are available on the market, for example under the trade names Nafion or fumapem. They are polymers, which, with the addition of highly acidic sulfonic acid groups, have certain ionic properties (so-called ionomers) and are selectively conductive for cations.

The use of a chemically stable, perfluorinated solid electrolyte in ultrapure water applications has one advantage that by contrast with conventional reference electrodes with liquid electrolytes, the material cannot release any impurities into the water.

According to one embodiment, the contact point between the second end of the cationic exchange material and the reference electrode is encapsulated in a housing. A drying agent can also be provided in the housing. It is also possible to use other means or ways for determining and/or influencing the humidity inside the housing, for example sensors.

This has one advantage of ruling out an influence by the humidity on the reference potential. Basically, the reference potential is determined by the PFSA material and its water content. The influence by the humidity persists in the dry state of the PFSA material. So that a constant reference potential is achieved, it is therefore necessary to keep the relative humidity of the electrode constant by encapsulating it in a housing. This can be improved if a drying agent can also be provided in the housing and/or if the humidity is monitored in another way.

The reference electrode typically contains a metal oxide. Possible oxides include, for example, PbO₂, RuO₂, and IrO₂. The electrical conductivities of these is very good and reversible redox reactions can occur on their surfaces. The oxide material can in particular be used in the form of a powder or in the form of a coating on an electrochemically inert substrate metal, such as titanium. According to the following reaction equation, the electrode potential of these oxides depends on the activity of the protons that are present in the electrolyte (pH value) and that of the water:

MOₓ+H₃O⁺+e″→MOₓ₋₁OH +H₂O.

In this equation, M stands for a metal that can form an electrically conductive oxide MOₓ.

According to one embodiment, the measuring electrode contains gold. Alternatively, platinum would also be a suitable material for the measuring electrode. But as has surprisingly turned out to be the case, when a gold-containing electrode is used, the concentration of ozone can be correlated with the measured potential even in the presence of hydrogen, thus enabling a meaningful determination of the ozone concentration. One reason for this is that the gold surface is oxidized very specifically by dissolved ozone and that the magnitude of the oxide layer on the gold determines the potential. As it has turned out, hydrogen and other reducing agents either do not react with the gold or only react with it very slowly. With gold as the electrode material, it is thus possible to produce a potentiometric sensor capable of measuring ozone dissolved in water, even in the presence of hydrogen.

This has one advantage that the potentiometric measurement can also be used in systems in which ozone is produced electrolytically. In such systems, hydrogen is produced as a byproduct and, depending on the process, can be released into the water together with the ozone. For such applications, the device solves one problem of measurement in the presence of hydrogen.

Electrolytic ozone generators are used not only in ultrapure water systems, but also in other water treatment systems for waste water or industrial water.

According to one embodiment of this invention, the device is used for monitoring an ozone concentration in a water treatment system. In particular, the water treatment system can be embodied as an ultrapure water system.

According to one embodiment of this invention, the device is used for monitoring the ozone concentration in the presence of hydrogen dissolved in the water.

The device can therefore be advantageously used to measure the ozone concentration and/or to monitor the ozone concentration in a water treatment system in which an electrolytic ozone production takes place. In this case, the measurement can take place in both ultrapure water and in water that contains foreign substances, such as waste water or industrial water. Consequently, the device also enables the use of potentiometry as a simple and quick measuring method for monitoring quality in water systems with electrolytic ozone generators. The invention is not restricted, however, to use in connection with electrolytically produced ozone and/or ultrapure water.

Since ion exchange materials in the presence of dissolved salts go into equilibrium with these salts, when the described device is used, the establishment of an equilibrium between the cationic exchange material and the analyte can be expected due to the occurrence of membrane potentials. Depending on the application the time of this process can take anywhere from hours to days. This is not a disadvantage, however, in mediums with an ion composition that does not change over longer periods of time, as is particularly the case when used as a monitor for the ozone concentration in an industrial or municipal water system.

According to another aspect of this invention, a method is disclosed for determining an ozone concentration in an aqueous solution, which includes the provision of the described device, the immersion of the cationic exchange material with its first end in the aqueous solution and the immersion of the measuring electrode in the aqueous solution, with the measuring electrode touching the cationic exchange material and forming an interface with it.

### BRIEF DESCRIPTION OF THE DRAWING

Embodiments of this invention will be described in greater detail below in view of a FIGURE that shows a device for determining the ozone concentration according to one embodiment of this invention.

### DETAILED DESCRIPTION OF THE INVENTION

The device 1 for determining the ozone concentration includes a measuring electrode 3, which is immersed in the analyte 2 in the depiction according to the FIGURE. The analyte 2 is water, for example ultrapure water, with ozone dissolved in it, which is used, for example, for water treatment.

The device 1 also includes a reference electrode 9. The potential between the reference electrode 9 and the measuring electrode 3 is measured, which makes it possible to determine the ozone concentration in the analyte 2. A cationic exchange material 6 is guided through an opening 4 which is sealed in relation to the outside by means of or with a seal 5 into the vessel containing the analyte 2 and produces the electrolytic contact between the measuring electrode and reference electrode.

The measurement of the potential in order to determine the ozone concentration therefore does not occur directly by means of or with the immersion of the reference electrode 9 in the analyte 2. Instead, the cationic exchange material 6 serving as the solid electrolyte is positioned between the reference electrode 9 and the analyte 2. In the embodiment shown, a PFSA material (perfluorinated sulfonic acid) is used as the cationic exchange material 6. The tubular cationic exchange material 6 used in one embodiment shown serves as an electrolyte bridge or fixed ion conductor in this case and is in protonated form. Where it dips into the analyte 2, an interface 10 with the measuring electrode 3 forms. At the interface 10 between the cationic exchange material 6 and the measuring electrode 3, a potential can be established, which depends on the concentration of the ozone dissolved in the water.

The cationic exchange material 6 protrudes with its first end 7 into the analyte 2, through the same opening 4 in the exemplary embodiment shown. This is where the interface 10 with the measuring electrode 3 forms. With its second end 8, the cationic exchange material 6 protrudes out from the analyte 2. The second end 8 is encapsulated in a gas-tight fashion in a housing 11 in order to keep the relative humidity of the reference electrode 9 constant. This is done at least for the following reason: the cationic exchange material 6 constitutes a medium with a definite proton concentration, such as pH value. Consequently, the reference potential is determined by the cationic exchange material 6 and the water content thereof. The water content of PFSA materials in the air-dried state is a function of the humidity. If the humidity is kept constant, as is done here by the encapsulation, this yields a constant potential of the reference electrode 9.

The reference electrode 9 contains a metal oxide material. Possible oxides, for example, include PbO₂, RuO₂, and IrO₂.

The measuring electrode 3 in the embodiment shown has a surface made of gold. By comparison with platinum, which would also be suitable for the measuring electrode 3, gold has the advantage that in the presence of hydrogen, the gold surface is specifically oxidized by dissolved ozone and the magnitude of the oxide layer on the gold determines the potential. By contrast, hydrogen and other reducing agents clearly do not react with the oxide or only react with it slowly. This has one advantage that the use of a gold electrode as the measuring electrode 3 makes it possible to determine the ozone concentration even in the presence of hydrogen.

In the absence of hydrogen, platinum can be used instead of gold, because the potential is established more rapidly in platinum.

German Patent Application DE 10 2015 108 496.1, filed 29 May 2015, the priority document corresponding to this invention, to which a foreign priority benefit is claimed under Title 35, United States Code, Section 119, and its entire teachings are incorporated, by reference, into this specification.

What is claimed is:

1. A device (1) for determining an ozone concentration in an aqueous solution, said device:
including at least one measuring electrode (3) that can be immersed in the aqueous solution;
at least one cationic exchange material (6) as a solid electrolyte that can be immersed with a first end (7) in the aqueous solution and with a second end (8) protruding out from the aqueous solution, the second end (8) contacting a reference electrode (9); and
to determine the ozone concentration, the first end (7) of the cationic exchange material (6) in the aqueous solution can be contacted by the measuring electrode (3).

2. The device (1) according to claim 1, wherein the cationic exchange material (6) is a PFSA material.

3. The device (1) according to claim 2, wherein a contact point between the second end (8) of the cationic exchange material (6) and the reference electrode (9) is encapsulated in a housing (11).

4. The device (1) according to claim 3 determining and/or influencing the humidity inside the housing (11).

5. The device (1) according to claim 4, wherein determining and/or influencing the humidity is embodied in a form of a drying agent.

6. The device (1) according to claim 5, wherein the reference electrode (9) contains a metal oxide.

7. The device (1) according to claim 6, wherein the measuring electrode (3) contains gold.

8. A use of the device (1) according to claim 7 for monitoring an ozone concentration in a water treatment system.

9. The use according to claim 8, wherein the water treatment system is embodied in the form of an ultrapure water system.

10. The use according to claim 9 for monitoring the ozone concentration in the presence of hydrogen dissolved in the water.

11. A method for determining an ozone concentration in an aqueous solution including:
a device (1) according to claim 7, wherein there is immersion of the cationic exchange material (6) with a first end in the aqueous solution, immersion of the measuring electrode (3) in the aqueous solution, and
wherein the measuring electrode (3) touches the cationic exchange material (6) and with it forms an interface (10).

12. A method for determining an ozone concentration in an aqueous solution including:
a device (1) according to claim 1, wherein there is immersion of the cationic exchange material (6) with a first end in the aqueous solution, immersion of the measuring electrode (3) in the aqueous solution, and
wherein the measuring electrode (3) touches the cationic exchange material (6) and with it forms an interface (10).

13. The device (1) according to claim 1, wherein a contact point between the second end (8) of the cationic exchange material (6) and the reference electrode (9) is encapsulated in a housing (11).

14. The device (1) according to claim 13 determining and/or influencing the humidity inside the housing (11).

15. The device (1) according to claim 14, wherein determining and/or influencing the humidity is embodied in a form of a drying agent.

16. The device (1) according to claim 1, wherein the reference electrode (9) contains a metal oxide.

17. The device (1) according to claim 1, wherein the measuring electrode (3) contains gold.

18. A use of the device (1) according to claim 1 for monitoring an ozone concentration in a water treatment system.

19. The use according to claim 18, wherein the water treatment system is embodied in the form of an ultrapure water system.

20. The use according to claim 8 for monitoring the ozone concentration in the presence of hydrogen dissolved in the water.
